(19) United States
(12) Patent Application Publication
(10) Pub. No.: US 2008/0149212 A1
(43) Pub. Date: Jun. 26, 2008

(54) Protection Tube Which Is Resistant To High Temperatures

(76) Inventors: Jordi Relats, Caldes de Montbui (Barcelona) (ES); Pere Relats, Caldes de Montbui (Barcelona) (ES); Dolors Artola, Caldes de Montbui (Barcelona) (ES); Anna Fruns, Caldes de Montbui (Barcelona) (ES)

Correspondence Address: NATH & ASSOCIATES, 112 South West Street, Alexandria, VA, 22314, US

(21) Appl. No.: 11/883,374

(22) PCT Filed: Dec. 2, 2004
(86) PCT No.: PCT/ES2004/000539

§ 371 Date: Jul. 31, 2007

(51) Int. Cl. F16L 9/02

(52) U.S. Cl. 138/177

(57) ABSTRACT

The invention relates to a protection tube which is resistant to high temperatures and which comprises a plurality of threads (1) which are braided, knit-braided or knitted to one another. Said threads (1) contain one or more metallic wires (3) therein.

The invention relates to a protection tube which is resistant to high temperatures, for example for the mechanical and thermal protection of automobile exhaust pipes.

### BACKGROUND TO THE INVENTION

At the present time protection tubes are used to product electrical conductors and other components, especially in the automobile industry.

These protection tubes must combine different characteristics that make them suitable for these types of uses.

In the first place, the protection tubes must have great mechanical and thermal resistance, as they are used in areas of high temperature and where they are subjected to abrasion.

In addition, these protection tubes must include noise insulation characteristics, as it would be unacceptable for these protection tubes to produce noise when used in automobiles.

In order to solve these disadvantages there are a great number of protection tubes that combine these characteristics and which are currently used to protect cables in automobiles.

One of the most important characteristics that these protection tubes must have is resistance to high temperatures.

At the present time there are protection tubes formed from a plurality of glass fibre threads which are braided, knit-braided and knitted to one another and coated with a silicone emulsion. These protection tubes are used to achieve good thermal insulation.

These types of protection tubes fulfil their aims but cannot support vibrations at very high temperatures, for example those in excess of 700° C. for glass fibre and 1,200° C. for silica fibres. This is due to the fact that the fibres lose their mechanical properties at these high temperatures, which prevents these protection tubes from being used for automobile exhausts, for example.

### DESCRIPTION OF THE INVENTION

With the protection tube of the invention the stated disadvantages are resolved, presenting other advantages which will be described.

The protection tube of this present invention comprises a plurality of threads which are braided, knit-braided or knitted to one another, and characterised because said threads contain one or more metallic wires therein.

In accordance with a preferred embodiment, said metallic wires are made from stainless steel.

By preference, said threads are made from glass or silica fibre and can be covered with a silicone emulsion.

With the protection tube of this present invention great thermal and mechanical resistance is achieved, even at very high temperatures above 700° C. and 1,200° C., as the metallic wires provided more mechanical resistance.

### A BRIEF DESCRIPTION OF THE DRAWINGS

In order to give a greater understanding of that which has been stated some drawings are included in which an outline of a practical embodiment is made which is made by way of being an example and without being by way of limitation.

FIG. 1 shows an outline view of a transverse section of the protection of the present invention; and

FIG. 2 shows a detail of a cross-section of one of said threads.

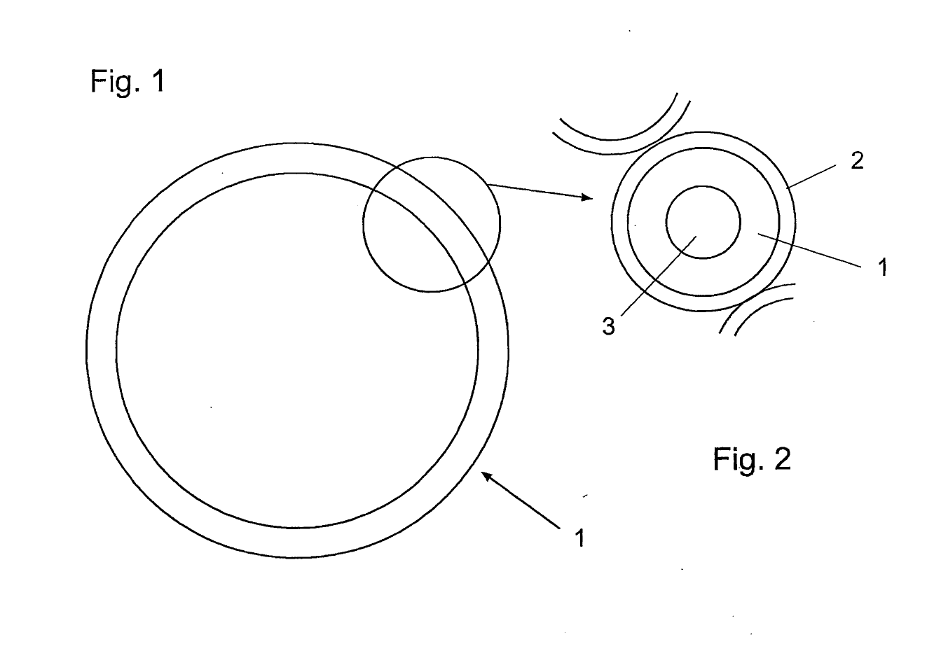

### DESCRIPTION OF PREFERRED EMBODIMENT

As and how it can be seen in the figures, the protection tube of the present invention comprises a plurality of threads (1) which are braided, knit-braided or knitted to one another. Said threads (1) are made from glass or silica fibre and are covered with a silicone emulsion (2).

In accordance with the invention, each one of these threads contains one or more metallic wires (3) therein, which are by preference made from stainless steel.

As has been stated previously, thanks to the presence of the metallic wire on the inside of the threads it is possible to use the protection tube of this present invention in places subjected to very high temperatures, even in excess of 700° C. and 1,200° C. depending on the material, for example for automobile exhausts.

In spite of the fact that reference has been made to a specific embodiment of the invention, it is clear for an expert in the subject matter that the protection tube described is capable of being used with numerous variations and modifications, and all of the details mentioned can be substituted for others that are technically equivalent, without departing from the scope of the protection defined by the attached claims.

1. Protection tube which is resistant to high temperatures, that comprises a plurality of threads (1) which are braided, knit-braided or knitted to one another, characterised in that said threads (1) contain one or more metallic wires (3) therein.

2. Protection tube according to claim 1, characterised in that said metallic wires (3) are made from stainless steel.

3. Protection tube according to claim 1, characterised in that said threads (1) are made from glass or silica fibre.

4. Protection tube according to claim 1, characterised in that said threads (1) are covered with a silicone emulsion (2).

5. Protection tube according to claim 3, characterised in that said threads (1) are covered with a silicone emulsion (2).
